(19) United States
(12) Patent Application Publication
(10) Pub. No.: US 2023/0214896 A1
(43) Pub. Date: Jul. 6, 2023

(54) Homebar Delivery App

(71) Applicant: Karmen White, Murfreesboro, TN (US)

(72) Inventor: Karmen White, Murfreesboro, TN (US)

(21) Appl. No.: 17/570,238

(22) Filed: Jan. 6, 2022

(51) Int. Cl. G06Q 30/06; G06Q 10/08

(52) U.S. Cl. CPC G06Q 30/0607; G06Q 30/0637; G06Q 30/0613; G06Q 10/0832; G06Q 10/0834

(57) ABSTRACT

The disclosed HomeBar Delivery App is the only one-stop-shop ordering and delivery app developed to simplify party planning. It provides access to a variety of pre-made appetizer and drink selections which may include catering services; do it yourself meals and/or alcoholic/non-alcoholic beverages and respective ingredients that populate into a shopping cart for easy ordering; party supplies and/or ambiance enhancement services and access to a directory of bartenders all conveniently in one app. In other words, it allows users to order a variety of alcoholic and nonalcoholic beverages and ingredients for their preferred drinks, as well as appetizers and other party supplies, with an option of hiring a bartender.

### BACKGROUND

Currently you must either have a vast knowledge of beverage mixes to create a variety of alcoholic and nonalcoholic beverages as well as many ingredients on hand or go to an establishment that provides ingredients or serves the premade versions of said such beverages. In some cases, you may even need to hire a bartender. It can be frustrating to be able to provide a variety for yourself or when hosting a function or party as it often may require extensive research of such mixtures, respective ingredients and even available bartenders. And that is just for the drinks. You must also do the same for appetizers you may wish to serve and for decorations to enhance the atmosphere. There have been no products available as original equipment or as an aftermarket to address this problem in one apparatus.

An apparatus that simplifies the process of having and ordering a variety of pre-made beverages and meals, based on the user's guest size, which may include caterings services; do-it-yourself recipes for beverages and meals; décor and/or ambiance enhancement services, and access to a bartender directory and/or services, all conveniently and effectively embedded into one device. There have been no products available as original equipment or as an aftermarket to address this problem either.

There exists a need for an application such as the HomeBar Delivery App that is not being met by any known or disclosed device or system.

### SUMMARY OF THE INVENTION

The HomeBar Delivery App is a one-stop-shop mobile app that simplifies the process of recreating your favorite bar-like drinks and environment for private or social gatherings from the luxury of you home and without the tedious tasks of laborious party-planning, in-store shopping and even cooking—when pre-made options are selected. The HomeBar Delivery App provides access to a variety of favorite meals, beers, wine, alcoholic/non-alcoholic beverages, and applicable recipes in which ingredients can be easily selected and populated into one or more carts for delivery, catering services, or pick-up. The app allows convenience and diversity so that the you and/or your guest do not become tiresome of repetitively planned cuisines, spirits and styles.

An alcohol purchasing device disclosed includes a profile generator configured to generate a user profile for a user of the device; a profile validator configured to validate the user and respective guests profiles by cross references to validating authorities each time an order for alcohol is placed on the device; and a transportation manager configured to arrange and to validate a transportation need of the user.

### BRIEF DESCRIPTION OF THE DRAWINGS AND LIST OF FIGURES

FIG. 1 is a flow chart of The HomeBar Delivery App showing the mobile application in accordance with an embodiment of the present disclosure.

FIG. 2 is a block diagram of the HomeBar Delivery App showing the mobile application in accordance with an embodiment of the present disclosure.

FIG. 3 is an additional flow chart of The HomeBar Delivery App showing the mobile application in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

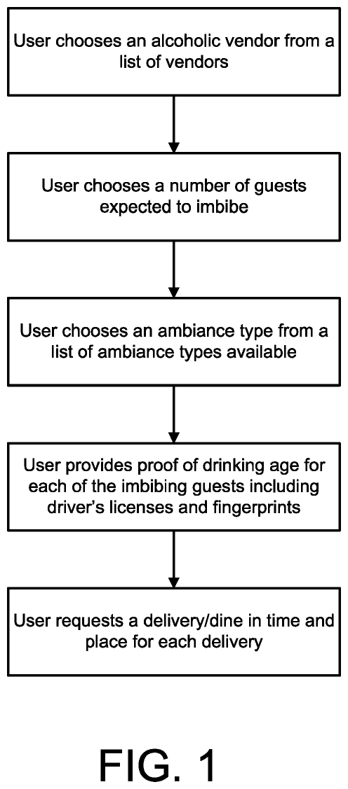

FIG. 1 is a flow chart of The HomeBar Delivery App showing the mobile application in accordance with an embodiment of the present disclosure. The depiction includes a step for the user to choose an alcoholic vendor from a list of vendors. The user also chooses an alcohol type and quantity from a drinks menu. The user or users also choose a number of guests who will drink alcohol and provides validated identification for each guest. The user and users also choose an ambiance type from a list of validated ambiances available at the vendors of interest. The user provides proof of drinking age for each of the imbibing guests including driver's licenses and fingerprints. Furthermore, the user and users request a delivery time and place for each delivery.

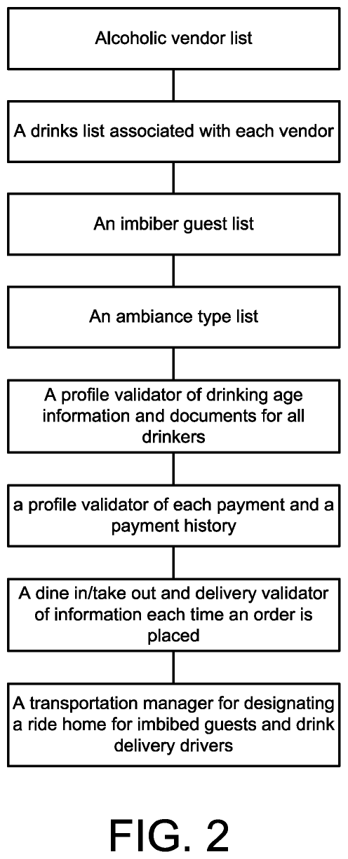

FIG. 2 is a block diagram of components of the HomeBar Delivery

App showing the mobile application in accordance with an embodiment of the present disclosure. The block diagram includes a vendor list, a drinks list associated with each vendor, an imbiber guest list and an ambiance type list. The lists are generated by subscription of vendors and are validated by a validator each time an order is placed on the disclosed application. The validator includes circuits implemented as state machines, microprocessors and non-volatile memory storage. The block diagram also includes a profile validator of drinking age information and documents including validated driver's licenses and finger prints. The block diagram also includes a dine in/take-out and delivery validator of information each time an order is placed on the disclosed application. Furthermore, the depicted block diagram includes a transportation manager for designating a ride home for imbibed guests and drink delivery drivers and validation circuits designed to validate the same per each order on the disclosed application.

The HomeBar Delivery App also simplifies the process of ordering your favorite appetizers and party supplies from various participating vendors based on your expected guest size. To make the package complete, the HomeBar Delivery App provides the option of hiring a bartender to mix and serve the drinks therefore, relieving the host from this duty, allowing him/her to focus on guests. Once the HomeBar Delivery App has been downloaded, the user will need to create an account profile which will require certain personal payment information, including establishing a secure password and/or fingerprint identity authentication for future access. The app will verify that the user is of a legal drinking age (individuals under the age of twenty-one are only allowed to view non-alcoholic menus and beverages). With GPS technology, the application will have knowledge of the operator's current location, however, orders may be delivered to any address of choice) provided all alcoholic deliveries are accepted by an individual over the age of 21). The user can also place an order for a future time and/or date. The user has the capability to scroll through a list of different mixed drinks, including virgin drinks, or search by using keywords once the user has personalized their order, an alcohol declaimer will appear and must be accepted by the user before the application order, an alcohol declaimer will appear and must be accepted by the user before the application confirms the delivery. The HomeBar Delivery App will prove to be a necessity for individuals who seek to have their favorite bar drinks for a night in, house parties, social gatherings, and/or date night functions. The disclosure also enables a user or users the ability to specify an ambiance for dine in applications and embodiments. The disclosure also includes a validator for transportation arrangement and management.

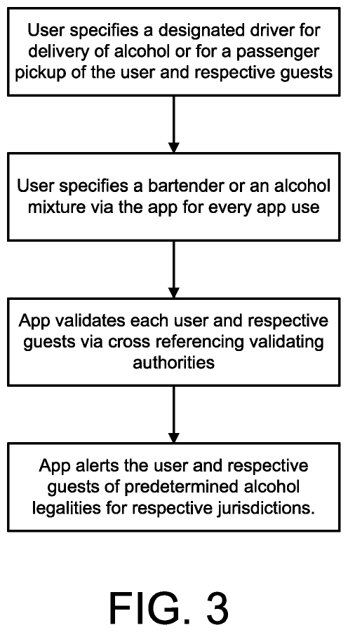

FIG. 3 is an additional flow chart of The HomeBar Delivery App showing the mobile application in accordance with an embodiment of the present disclosure. The additional steps depicted in the additional flow chart include the user specifying a designated driver via the disclosure for delivery of alcohol or for a passenger pickup from the user and respective guests. The users also specify an alcohol mixture via the app for every app use. The app validates each user and respective guests via cross referencing validating authorities. The app also alerts the user and respective guests of predetermined alcohol legalities for respective jurisdictions.

Embodiments of the disclosure further include a one stop shop app and no other app offers the diversity of ordering premade drinks and meals; DIY drinks and meals from which ingredients of selected recipes will populate into an online basket/cart, as needed and selected, for easy ordering. The one-stop-shop can be used for ordering decorations and/or ambiance enhancements, it provides access to a bartender directory and services and transportation management as required. It is also important to note that the variety and convenience of this app distinguishes the disclosure from other patents and development.

In other words, the date has been set and everything seems to be planned to perfection until the day of the party nears. Looking at the calendar, the clock and the to do list, the hosts realize there does not seem to be enough time to get everything done. They still need to finalize the perfect food and drink selections as well as head out to multiple stores in hopes of finding all ingredients as required. After spending hours searching for recipes and determining quantities needed for each item, the hosts begin to worry that perhaps the party was not planned as perfectly as initially assumed. The invitation says, “Appetizers and Drinks” and foregoing either one was definitely not an option! Unfortunately, extending the time to plan this party was not an option either! Succumbing to a compromised defeat, the hosts decided to make the appetizers the priority and surrendered to simply buying beer at the local grocery store over the preferred cocktails.

Whether planning an intimate rendezvous for two or a soirée for family or friends, organizing social gatherings may entail a great amount of thought and work. Selecting and cooking appetizers, hunting party supplies, and even exploring the Internet in hopes of discovering new and refreshing recipes, so that guests do not become tiresome with the lack of variation, can be arduous and discouraging—especially if the event happens after a full day of work. Even more, without a bartender present to attend to the larger crowds, the host may inconveniently be tasked with mixing drinks for each individual, taking time away from mingling with guests.

Ingenious and practical, the HomeBar Delivery App is a one-stop-shop mobile app that simplifies the process of recreating your favorite bar-like drinks, meals and ambiance for social gatherings from the luxury of your home without the many tedious tasks that comes along with shopping, cooking and overall party planning. The HomeBar Delivery App provides easy access to ordering the decor of your choice to help spruce up the environment and a variety of Do-It-Yourself (DIY) recipes of your favorite meals, alcoholic and nonalcoholic beverages with which selection of ingredients will conveniently populate into your cart. The HomeBar Delivery App eliminates the hassle of constant research and endless Internet searches, hoping to find the perfect recipes and provides the option to be creative and do it yourself or simply order premade drinks, foods and party supplies from various participating vendors so that you and/or your guest do not become tiresome of the same drinks and food. To make the package complete, the HomeBar Delivery App provides access to a directory of Bartenders who can mix and serve those drinks for you based on their availability; therefore, relieving the host from this duty, allowing him/her to focus on guests.

The HomeBar Delivery App appeals to an array of consumers, especially hosts who appreciate a little bit of party planning assistance! People who frequently have guests over or throw social functions often desire variety but may get discouraged by the effort required to create it and commonly think, “I wish there was an easier way to get everything needed without all the work!”

Falling into the category of persons who sought an easier method to planning a party while offering and enjoying her favorite appetizers and mixed drinks (Mai-Tai, Long Island Iced Tea, etc.), the Inventors realized the need to create something that helped bring the bar “home” so that they didn't always have to leave the house or work too hard to recreate her bar-selected favorites!

The inventor has developed a beneficial method that will assist people so that they can recreate and enjoy their favorite bar-like environments, cocktails and appetizers without the hassle of recipe hunting, going to the bar, extensive shopping and party planning. This method offers convenience and provides the user with flexibility of catering to guests of any size. Aptly named and created, the HomeBar Delivery App is a one-stop-shop mobile app that simplifies the process of recreating your favorite bar-like drinks and environment from the luxury of your home; it provides variety and assistance and puts the fun back into planning!!

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. An alcohol purchasing device comprising:
a profile generator configured to generate a user profile for a user of the device and respective guests of the user;
a profile validator configured to validate the user and respective guests profiles by cross references to validating authorities each time an order for alcohol is placed on the device; and
a transportation manager configured to arrange and to validate a transportation need of the user and respective guests.

2. The device of claim 1, wherein the profile includes a user's preference of an ambiance type offered by a vendor for each use of the device by the user including an ambiance enhancement offered by the vendor.

3. The device of claim 1, wherein the user profile and the guests profiles include a drinking age of the user and the respective guests.

4. The device of claim 1, further comprising a vendor selection generator configured to generate a vendor plurality for the user.

5. The device of claim 1, further comprising a vendor validator configured to validate a vendor plurality each time the order is placed on the device.

6. The device of claim 1, wherein the transportation need of the user and respective guests includes a non-imbibed designated driver.

7. The device of claim 1, wherein the transportation need of the user and respective guests includes a delivery driver for the order.

8. The device of claim 1, wherein the transportation manager includes a vehicle for hire service.

9. The device of claim 1, wherein the transportation manager includes a food delivery service.

10. The device of claim 1, wherein the profile generator and the profile validator comprise electronic circuits and interconnect there between.

11. The device of claim 1, wherein the transportation manager comprises electronic circuits and interconnect there between.

12. The device of claim 1, wherein the validator cross references include a department of motor vehicles.

13. The device of claim 1, wherein the validator cross references include a law enforcement agency.

14. The device of claim 1, wherein the validator cross references include a third independent identity validating party.

15. The device of claim 1, further comprising a circuit configured to select a favorite bartender from a bartender directory for the order.

16. The device of claim 1, further comprising a circuit configured to select a favorite designated driver of the user for the user and respective guests.

17. The device of claim 1, further comprising a disclaimer circuit configured to alert the user of respective and predetermined legalities regarding an imbibing of alcohol in a jurisdiction of the user's domicile.

18. The device of claim 1, further comprising a shopper's cart of a plurality of preselected ingredients for a drink for the user and for the respective guests.

19. The device of claim 1, further comprising a cart of premade food and drinks, accompanied by do it yourself recipe ingredients for the food and the drinks.

20. The device of claim 1, further comprising a circuit configured to implement an order for a user's preselection of an ambiance type offered by a vendor including an ambiance enhancement offered by the vendor.
